(19) United States
(12) Patent Application Publication
(10) Pub. No.: US 2005/0170696 A1
(43) Pub. Date: Aug. 4, 2005

(54) Braid cutting apparatus

(75) Inventor: Masaki Matsuoka, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/043,953

(22) Filed: Jan. 28, 2005

(30) Foreign Application Priority Data
Jan. 29, 2004 (JP) P2004-021126

(51) Int. Cl. H01R 9/03

(52) U.S. Cl. 439/610

(57) ABSTRACT

In a braid cutting apparatus 10, a tubular braid 13, fitted on an outer periphery of a conductor 12, is inserted into a die 15 having an outer blade 15A, and a punch 16, having an inner blade 16A, is forcibly inserted between the braid 13 and the conductor 12, so that the braid 13 is held between the punch 16 and the die 15 to be cut by the two blades 16A and 15A of the punch 16 and die 15. In this braid cutting apparatus 10, an outer peripheral edge of a distal end 18 of the punch 16 is chamfered so as to prevent each of wire elements 17, forming the braid 13, from being caught by the distal end 18, thereby preventing the wire element 17 from being bent into a generally crank-shape by the punch.

### BACKGROUND OF THE INVENTION

1. Field of the Invention

This invention relates to a braid cutting apparatus in which a tubular braid, fitted on an outer periphery of a conductor, is inserted into a die, and then a punch is forced in (or forcibly inserted) between the braid and the conductor, and the braid is cut by the punch and the die.

2. Related Art

There is known the type of braid cutting apparatus in which a braid, fitted on a distal end portion of a conductor, is cut by a die and a punch. The braid cutting apparatus is shown in Unexamined Japanese Patent Application Sho55-66210.

FIG. 5 is a view showing a braid cutting operation disclosed in this conventional art. First, a braid 51, covering a conductor 50, is removed over a predetermined length from a distal end 50A of the conductor 50.

Then, the conductor 50 and the braid 51 are inserted into a die 53 having an outer blade 53A, so that the distal end 50A of the conductor 50 and a distal end 51A of the braid 51 project beyond the die 53.

That portion of the braid 51, projecting from the die 53, is spread into a trumpet bell-like shape (that is, flared gradually toward the distal end thereof), and a punch 54 with an inner blade 54A is forcibly inserted between the flared braid 51 and the conductor 50.

As a result, the braid 51 is held between the two blades 54A and 53A of the punch 54 and die 53, and that portion of the braid 51, held between the two blades 54A and 53A of the punch 54 and die 53, is sheared (cut) by the two blades 54A and 53A.

As shown in FIG. 6, the braid 51 is formed by weaving wire elements 56 into a meshed tubular structure. Therefore, there is a fear that the distal end (that is, the inner blade 54A) of the punch 54 intrudes into a mesh of the braid 51 during the insertion of the punch 54 between the braid 51 and the conductor 50, and is caught by the wire element 56, so that the thus caught wire element 56 is bent into a generally crank-shape by this distal end.

In case the wire element 56 is thus bent into a generally crank-shape, this wire element 56 (bent into the generally crank-shape) is cut at three portions 56A, 56B and 56C thereof when the braid 51 is cut by the two blades 54A and 53A (see FIG. 5) of the punch 54 and die 53 (see FIG. 5).

When the wire element 56 is thus cut at the three portions 56A, 56B and 56C, sheared-off portions 57 and 57 (i.e., chips) of the wire element drop off the braid 51.

Therefore, much time and labor are required for removing the dropped chips 57 and 57, and this has prevented the productivity from being enhanced.

### SUMMARY OF THE INVENTION

It is an object of this invention to provide a braid cutting apparatus in which each of wire elements of a braid is prevented from being bent into a generally crank-shape by a punch when the punch is forcibly inserted between a braid and a conductor.

The above object has been achieved by a braid cutting apparatus in which a tubular braid, fitted on an outer periphery of a conductor, is inserted into a die having an outer blade, and a punch, having an inner blade, is forcibly inserted between the braid and the conductor, so that the braid is held between the punch and the die to be cut by the two blades of the punch and die; provided in that an outer peripheral edge of a distal end of the punch is chamfered so as to prevent each of wire elements, forming the braid, from being caught by the distal end, thereby preventing the wire element from being bent into a generally crank-shape by the distal end.

In this braid cutting apparatus, the outer peripheral edge of the distal end of the punch is chamfered. Therefore, the distal end of the punch will not intrude into a mesh of the braid during the insertion of the punch between the braid and the conductor, and therefore will not be caught by the wire element of the braid.

Since the distal end of the punch will not be caught by any of the wire elements of the braid, the wire element is prevented from being bent into a generally crank-shape by the punch.

Therefore, the wire element will not be cut at three portions thereof when the braid is cut by the two blades of the punch and die.

In the braid cutting apparatus of the invention, each of the wire elements is prevented from being cut at its three portions so that cut-off braid chips (which would otherwise be produced) will not drop off the braid, and therefore there is obtained an advantage that the time and labor, required for removing such dropped braid chips, are saved, so that the productivity can be enhanced.

### BRIEF DESCRIPTION OF THE DRAWINGS

FIG. 1 is a cross-sectional view of a braid cutting apparatus of the invention.

FIG. 2 is a side-elevational view of a punch of the braid cutting apparatus of the invention.

FIGS. 3(A) and 3(B) are views explanatory of features of the punch of the braid cutting apparatus of the invention.

FIGS. 4(A) to 4(C) are views explanatory of an example in which a braid is sheared by the braid cutting apparatus of the invention.

FIG. 5 is a cross-sectional view of a conventional braid cutting apparatus.

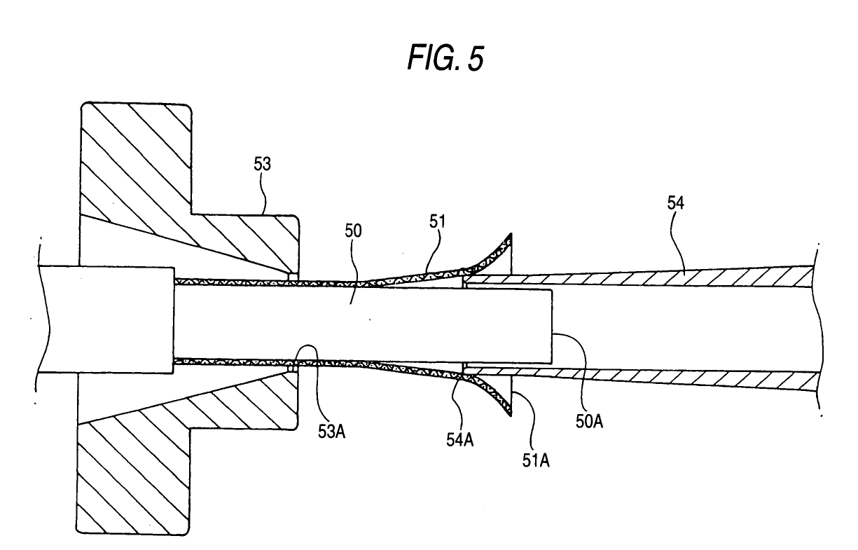

FIG. 6 is a view explanatory of an operation of the conventional braid cutting apparatus.

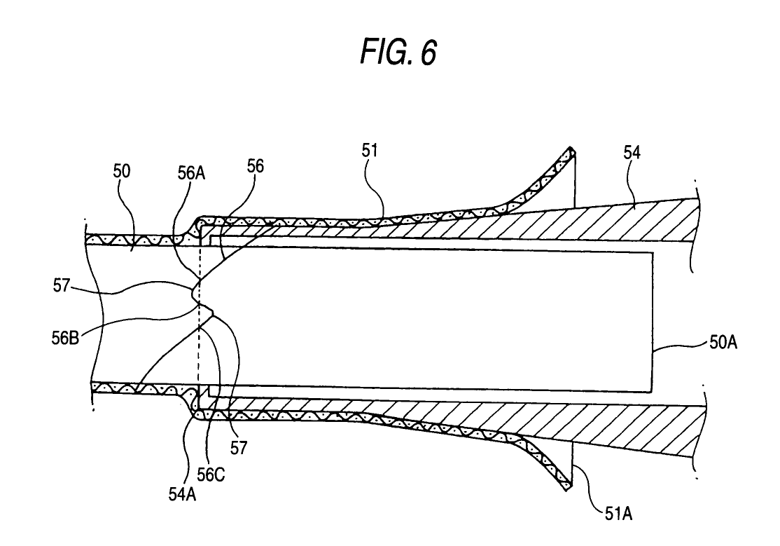

### DETAILED DESCRIPTION OF THE PREFERRED EMBODIMENTS

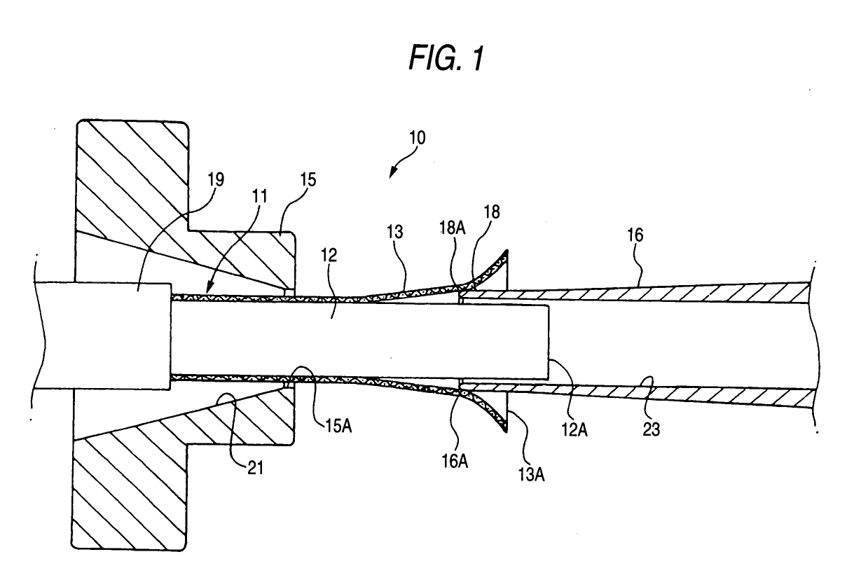

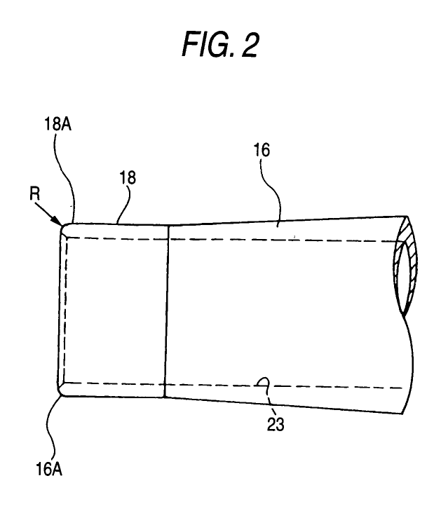

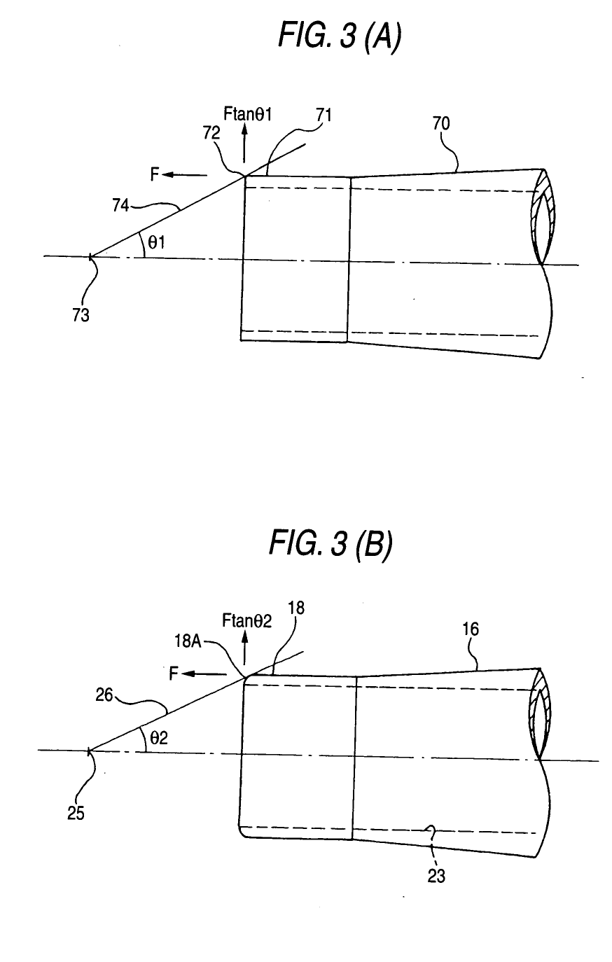

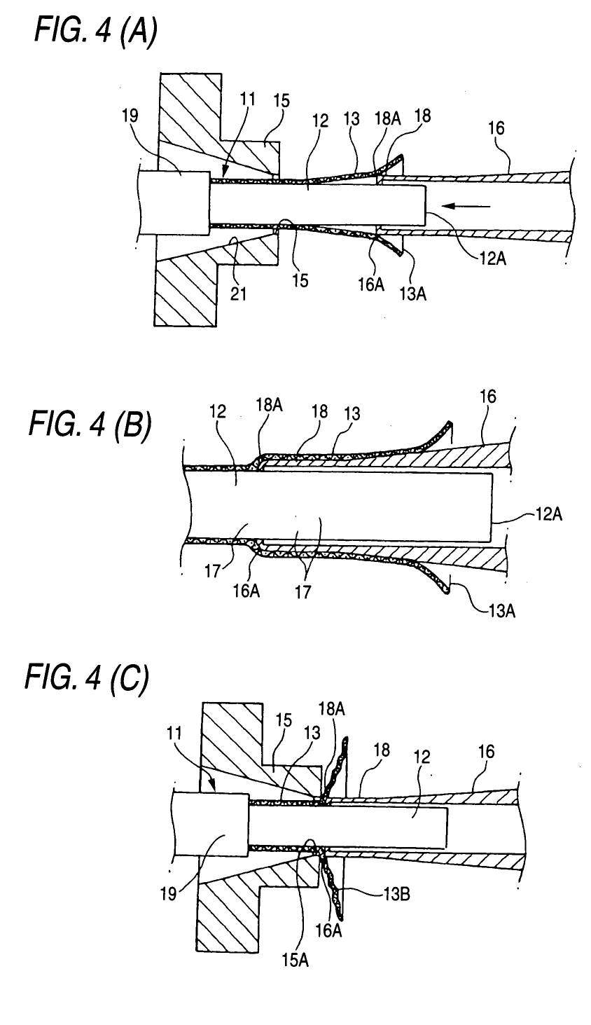

A preferred embodiment of the present invention will now be described in detail with reference to the drawings. FIG. 1 is a cross-sectional view of a braid cutting apparatus of the invention, FIG. 2 is a side-elevational view of a punch of the braid cutting apparatus of the invention, FIGS. 3A and 3B are views explanatory of features of the punch of the braid cutting apparatus of the invention, and FIGS. 4A to 4C are views explanatory of an example in which a braid is sheared by the braid cutting apparatus of the invention.

In the braid cutting apparatus 10 of the first embodiment shown in FIG. 1, the tubular braid (shielding wire) 13, fitted on a conductor 12 of a cable 11, is inserted into a die 15 having an outer blade 15A, and the punch 16, having an inner blade 16A, is forcibly inserted between the braid 13 and the conductor 12, and the braid 13 is held between the punch 16 (the inner blade 16A) and the die 15 (the outer blade 15A) to be cut (sheared) by the two blades 16A and 15A of the punch 16 and die 15.

In the braid cutting apparatus 10, an outer peripheral edge of a distal end 18 of the punch 16 is chamfered as at 18A so as to avoid a situation in which each of wire elements 17 (which forms the braid 13) is caught by the distal end 18 of the punch 16, and is bent into a generally crank-shape by the distal end 18.

The cable 11 comprises the conductor 12, the tubular braid 13 fitted on the outer periphery of the conductor 12, and a resin-made protective layer 19 covering the braid 13.

The braid 13 is formed by weaving the wire elements 17 (see FIG. 4B) into a meshed tubular structure.

The die 15 has a through hole 21 of a tapering shape for the passage of the cable 11 therethrough, and the outer blade 15A is provided at a distal end portion of the through hole 21.

The punch 16 has a through hole 23 for the insertion of the conductor 12 thereinto, and also has the inner blade 16A provided at the distal end 18 thereof. The inner blade 16A can be inserted into the braid 13, and also can be inserted into the outer blade 15A of the die 15.

As shown in FIG. 2, the chamfered portion 18A is formed at the outer peripheral edge of the distal end 18 of the punch 16, and a radius R of the chamfered portion 18A is set to a suitable value.

The value of the radius R is so determined that the distal end 18 of the punch 16 will not be caught by any of the wire elements 17 (see FIG. 4B) of the braid 13 when forcibly inserting the punch 16 between the braid 13 and the conductor 12 (see FIG. 1), and also the value of the radius R is so determined that the two blades 16A and 15A of the punch 16 and die 15 can shear (cut) the braid 13 (see FIG. 1) satisfactorily.

Next, a force to push up the braid by the distal end of the punch will be described with reference to FIGS. 3A and 3B.

FIG. 3A shows a comparative example in which an outer peripheral edge 72 of a distal end 71 of a punch 70 is not chamfered. FIG. 3B shows the embodiment of the invention in which the chamfered portion 18A with the radius R is formed at the outer peripheral edge of the distal end 18 of the punch 16.

In FIG. 3A, there is obtained an inclination angle θ1 between a centerline 73 of the punch 70 and an extension line 74 extending from the centerline 73 to the outer peripheral edge 72.

When this punch 70 is moved in a direction of an arrow by a pressing force F, there is produced a push-up force (F×tan θ1) to push up the braid 13 (see FIG. 1).

In FIG. 3B, there is obtained an inclination angle θ2 between a centerline 25 of the punch 16 and an extension line 26 extending from the centerline 25 to the chamfered portion 18 of the outer peripheral edge. Here, when the chamfered portion 18A with the suitable radius R is formed at the outer peripheral edge of the distal end 18 of the punch 16, the relation θ2<θ1 is established when this punch 16 is moved in a direction of an arrow by a pressing force F, there is produced a push-up force (F×tan θ2) to push up the braid 13 (see FIG. 1).

Since the relation θ2<θ1 is established, the relation F×tan θ2<F×tan θ1 is established.

Therefore, the push-up force, acting on the braid 13 when pushing the punch 16 of this embodiment into the braid 13 (see FIG. 1), is reduced. Therefore, the outer peripheral edge of the distal end 18 of the punch 16 is more positively prevented from being caught by any of the wire elements 17 (see FIG. 4B) of the braid 13.

Next, the operation of the braid cutting apparatus 10 will be described with reference to FIGS. 4A to 4C.

As shown in FIG. 4A, the braid 13 is removed over a predetermined length from a distal end 12A of the conductor 12, and the conductor 12 and the braid 13 are inserted into the die 15 having the outer blade 15A, so that the distal end 12A of the conductor 12 and a distal end 13A of the braid 13 project beyond the die 15.

That portion of the braid 13, projecting from the die 15, is spread into a trumpet bell-like shape (that is, flared gradually toward the distal end 13A thereof), and the punch 16 with the inner blade 16A is forcibly inserted between the flared braid 13 and the conductor 12 in a direction of an arrow.

The chamfered portion 18A with the suitable radius R is formed at the outer peripheral edge of the distal end 18 of the punch 16, and therefore the outer peripheral edge of the distal end 18 of the punch 16 can be smoothly inserted into the braid 13.

In addition, the push-up force, acting on the braid 13 when pushing the punch 16 into the braid 13, can be reduced to F×tan θ2 (see FIG. 3B).

Therefore, the outer peripheral edge of the distal end 18 of the punch 16 is prevented from being caught by any of the wire elements 17 of the braid 13.

Therefore, the punch 16 can be satisfactorily inserted between the braid 13 and the conductor 12 without disturbing the meshwork of the braid 13.

As shown in FIG. 4C, the punch 16 is thus inserted between the braid 13 and the conductor 12 without disturbing the meshwork of the braid 13, so that the braid 13 is held between the inner blade 16A of the punch 16 and the outer blade 15A of the die 15.

That portion of the braid 13, held between the inner blade 16A of the punch 16 and the outer blade 15A of the die 15, is sheared (cut) by the two blades 16A and 15A of the punch 16 and die 15.

As a result, a distal end portion 13B of the braid 13 is removed from the braid 13.

In the braid cutting apparatus 10, the chamfered portion 18A is formed at the outer peripheral edge of the distal end 18 of the punch 16.

Therefore, the outer peripheral edge of the distal end 18 of the punch 16 will not intrude into a mesh of the braid 13 during the insertion of the punch 16 between the braid 13 and the conductor 12, and therefore will not be caught by the wire element 17 (see FIG. 4B), thereby preventing the wire element 17 from being bent into a generally crank-shape by the punch.

Therefore, the wire element 17 (see FIG. 4B) will not be cut at three portions thereof when the braid 13 is sheared (cut) by the two blades 16A and 15A of the punch 16 and die 15.

Since the wire element 17 will not be cut at its three portions, braid chips (not shown) will not be produced.

Therefore, such braid chips will not drop off the braid. Therefore, there is obtained an advantage that the time and labor, required for removing the dropped braid chips, are saved, so that the productivity can be enhanced.

The invention is not limited to the braid cutting apparatus 10 of the above embodiment, and suitable modifications, improvement and so on can be made.

For example, although the chamfered portion 18A has the radius R, the chamfered portion of the invention is not limited to the radius R, but can be formed into a slanting surface C or a bevel portion.

The material, shape, dimensions, form, number, disposition, etc., of each of the conductor 12, braid 13, die 15, outer blade 15A, punch 16, inner blade 16A, wire elements 17, chamfered portion 18A and so on are arbitrary, and are not limited in so far as the invention can be achieved.

1. A braid cutting apparatus comprising:
a die, having an outer blade, inserting into a tubular braid fitted on an outer periphery of a conductor;
a punch, having an inner blade, forcibly inserted between the tubular braid and the conductor to cut the tubular braid; and
a smoothing portion formed on an outer peripheral edge of a distal end of the punch.

2. A braid cutting apparatus as claimed in claim 1, wherein the smoothing portion is defined by one of the round sharp portion, chamfer portion and beveled portion.
